(19) United States
(12) Patent Application Publication
(10) Pub. No.: US 2008/0036107 A1
(43) Pub. Date: Feb. 14, 2008

(54) UNIT PROCESS FOR THERMOFORMING COMPLICATED FORMS

(75) Inventors: Chor K. Yeung, Chaudenay (FR); Sophie Perez, Marchais En Brie (FR); Frederic Bony, Brasles (FR)

Correspondence Address: CONNOLLY BOVE LODGE & HUTZ LLP;(FOR CABINET BEAU DE LOMENIE), P.O. BOX 2207, WILMINGTON, DE, 19899-2207, US

(73) Assignee: AXON'CABLE

(21) Appl. No.: 11/780,906

(22) Filed: Jul. 20, 2007

(30) Foreign Application Priority Data
Jul. 21, 2006 (FR) 0653066

(51) Int. Cl. B29C 51/46

(52) U.S. Cl. 264/40.1; 264/548; 425/117

(57) ABSTRACT

Thermoforming a plastics material part, in particular a plate. According to the invention, the thermoforming unit comprises at least two molds (2, 3) of respective shapes that enable the shape of the material (1) being worked to be caused to vary progressively up to a final mold giving the desired shape. A thermoforming method using such a thermoforming unit.

The present invention relates to a thermoforming unit and to an associated thermoforming method that enable parts to be manufactured that are complex in shape. Such a unit can be used in particular for thermoforming flexible expanded membranes such as polytetrafluoroethylene (PTFE) membranes. The definition of the invention is associated with a definition of the method of designing tooling suitable for such units.

### DESCRIPTION OF THE PRIOR ART

Thermoforming is a well-known method of manufacturing plastics material parts having the shape of a thin shell. Its main advantages are as follows: it does not require raw material to be prepared; the tooling used is generally inexpensive; the method is simple and can be implemented quickly.

Nevertheless, with certain parts that are complex in shape, and when using certain thermoplastics that are fragile, thermoforming can turn out to be difficult or impossible. Various problems can arise: tears in the part; dimensional problems with it being impossible to obtain the desired shape; lack of dimensional stability which leads to parts being manufactured that are of a shape that is not stable over time; the appearance of thin zones that do not possess the expected mechanical or other properties.

These manufacturing problems can be even more difficult when making parts out of expanded plastics materials and in particular out of PTFE. This type of manufacture is particularly difficult. At a temperature that is too low, the plastics material does not deform properly and the desired shape is not achieved; at a temperature that is too high, the expanded structure disappears and the mechanical properties of the manufactured part no longer possess the expanded material properties that it is nevertheless desired to conserve. Partial amorphization of the structure of the PTFE membrane while preserving its mechanical properties is described in particular in U.S. Pat. No. 3,953,566 to Gore.

Furthermore, the behavior of such membranes is associated with their large elastic memory and with their capacity for expansion.

Under optimum thermoforming conditions, such membranes can be subjected to deformation of as much as 1000% (×10) of their initial size, which is an advantage for thermoforming. The thickness of the membrane decreases a little, with a reduction in density, but uniformly over the deformed area.

Nevertheless, with parts that are complex in shape, performing thermoforming can lead to parts being made that have zones of reduced strength.

Such zones are not to be found in portions of the mold where the membrane can deform freely. In contrast, such zones of reduced strength can appear in zones where the membrane makes contact with the mold, thereby limiting uniform distribution of deformation.

Thus, if a “female” mold is considered having a cavity of regular shape, e.g. having a section in the form of a circular arc, thermoforming can give a satisfactory result. However, for a complex shape, the deformation of the membrane in contact with the mold is not regular; this therefore leads locally to zones of high deformation. This is how zones of reduced thickness and of small mechanical strength come to be formed.

The object of the invention is to remedy the above-mentioned drawbacks of thermoforming devices by defining a thermoforming unit and a method suitable for enabling thermoformed parts to be produced that are of relatively constant thickness, and without encountering the above-mentioned manufacturing problems.

### DEFINITION OF THE INVENTION

These new manufacturing possibilities are achieved by the fact that the thermoforming is not performed in a single step, but in a plurality of successive forming steps.

The thermoforming unit of the invention thus comprises a series of at least two molds, in which the same sheet of plastics material is shaped in succession, the respective shapes of said molds serving to cause the shape of the sheet to vary progressively so that at the final step, a final mold enables the desired shape to be obtained. The molds used in steps prior to the final step are referred to as intermediate molds.

Similarly, the method of the invention for manufacturing a thin part out of plastics material comprises the following steps:

a) performing at least one intermediate thermoforming step by using therein at least one intermediate mold, the shape(s) of the intermediate mold(s) enabling the shape of the material being worked to be caused to vary progressively; and

b) performing a final thermoforming step during which a final mold enables the desired shape to be obtained.

Below, a shape, a surface, or a curve (e.g. a sectioning curve or section) is said to be “regularized” when it is replaced by a respective shape, surface, or curve, of more regular curvature. This can apply for example to a shape, a surface, or a curve for which the smallest radius of curvature within the zone under consideration is increased from its starting value.

In the thermoforming unit of the invention, the shape of a zone in one of the molds may advantageously be defined by regularizing the corresponding zone of the following mold (the mold to be used in the following step).

Advantageously, this regularization can be performed in application of various methods proposed below.

Regularization may be performed on the basis of selected sections measured on said zone in the following mold.

More precisely, this regularization can be performed in such a manner as to conserve the developed lengths of selected sections measured over said zone. This disposition then makes it possible during the following forming step to reduce the lengthening to which the material is subjected in the mold, thereby making it easier to obtain a part of constant thickness.

All or a portion of the above-mentioned sections may be regularized in particular by replacing the sections under consideration by curves that are simple, e.g. circular arcs or portions of an ellipse.

It should be observed that it is generally desirable to give an intermediate mold a shape that is close to that of the following mold and that is of comparable area. Preferably, the intermediate mold has an area that is equal to or even slightly greater than the area of the following mold. More simply, it can suffice to ensure that the developed lengths of selected sections of the intermediate mold are equal to or slightly greater than the developed lengths of corresponding sections of the following mold.

Thus, the membrane thermoformed in an intermediate step can occupy without difficulty the space provided for it in the following mold. Because of the shape memory of the membrane, the excess area formed during the intermediate step is reabsorbed during the following step.

Implementing this method makes it possible to obtain membranes of shapes that are complex and of thickness that is relatively uniform or homogeneous.

Another method of defining the shape of one of the molds consists in locally inverting the shape of the corresponding zone in the following mold, by performing a symmetrical transformation about a plane.

In order to obtain thermoformed parts of complex shape, the above-defined thermoforming unit should preferably be implemented while satisfying certain operating rules and using certain materials.

Thus, the thermoforming method fully achieves its result if the material used is an expanded plastics material, an expanded fluorinated thermoplastic material, or in particular a membrane of expanded PTFE.

Performing thermoforming using an intermediate mold in the thermoforming unit of the invention is particularly advantageous with expanded membranes, in particular when made of PTFE. Advantageously, shaping such membranes in a plurality of successive forming steps serves to solve the problems of zones of reduced thickness and of reduced mechanical strength appearing during manufacture.

In addition, for materials such as PTFE that change in translucency on reaching the crystalline melting temperature, temperature control during one of the forming operations can be advantageously be performed by observing the changes in the translucency of the material.

During forming the material worked should be taken briefly to a temperature that is higher than its crystalline melting temperature.

Furthermore, when the material worked possesses a specific elongation direction (the longitudinal axis of a membrane that has been expanded uniaxially, for example), and when the shape of a mold has been determined by modifying sections perpendicular to a given axis, the material can be put into place in the mold in such a manner that its specific elongation direction is parallel to said axis.

Finally, the characteristics of molds defined by the present invention enable the person skilled in the art to define novel forming units that possess the same suitability for producing parts that are complex in shape.

It will be understood that the term “mold” is used herein to designate any tooling or device for shaping plastics material.

### DESCRIPTION OF THE FIGURES

The invention can be well understood and its advantages appear better on reading the following detailed description of embodiments shown by way of non-limiting example. The description refers to the accompanying drawings, in which:

FIG. 1 is a diagrammatic section view of a thermoforming unit in accordance with the invention;

FIG. 2 shows an example of a shape that it is desired to obtain for a part;

FIGS. 3 and 4 are diagrams showing how the shape is determined for an intermediate mold for manufacturing the part; and

FIGS. 5 to 8 show another method of making an intermediate mold, making use of local symmetries relative to planes.

### DETAILED DESCRIPTION OF PREFERRED EMBODIMENTS

FIG. 1 shows a thermoforming unit in accordance with the invention. It comprises a set of molds 2, 3, a suction system (shown in part), and a heater system (not shown). Each mold is fitted with a plate-holder system 4. The suction system has one or more suction chambers 5, suction channels 6, and sealing gaskets 7 on the suction chambers.

The plate 1 of plastics material is put into place in the plate-holder system 4. The heater system softens the plate 1, while the suction system creates suction (in the example shown) in the suction chamber. The suction propagates via the suction channels to the hidden face of the plate 1. Under the effect of the pressure difference between its visible face and its hidden face, the plate 1 as softened by the heat becomes pressed against the mold and takes up its shape.

In the example of FIG. 1, the unit has only two molds corresponding to two forming steps. The plate is initially formed in the intermediate mold 2, thus taking on a shape of section that comes close to a semicircle in the example shown (dashed line 1A). Thereafter, the plate is formed in the final mold 3 during the final forming step that gives it the final shape 1B.

Because the part in the mold 2 was given a suitable preparatory shape close to its final shape, the forming operation of the final step gives good results, i.e. in particular the material is not excessively stretched or thinned and does not tear.

Instead of applying suction to the mold during the forming step, it is also possible to apply pressure to the visible face of the part, with the suction chamber, its sealing gaskets, and the suction channels being modified accordingly. Such dispositions are known to the person skilled in the art.

More generally, the thermoforming unit in accordance with the invention may comprise a plurality of molds of different shapes so as to be capable of performing successive forming operations: a plate is initially shaped on the first mold, and then after it has taken on its shape, it is shaped on the following mold, and so on, until the last mold which gives it its final shape (excluding any changes of shape associated with being extracted from a mold and cooling down). In general, the more the shape is complex with zones in which material is stretched greatly, the greater the number of molds required.

The molds shown in the figures are single-cavity molds, but naturally the method is applicable to multi-cavity molds.

The molds may be female molds, i.e. they outline or reproduce the convex side of the part. The molds could equally well be male molds. The use of female molds is preferable, since it is particularly simple to fasten such molds to the plates or membranes used for manufacture, as shown in FIG. 1.

Advantageously, molding is performed by suction rather than by injecting air under pressure. Such a molding makes it possible to heat the material directly on its free face using hot air, and to observe deformation so as to control the progress of the method. Heating can be performed by means of an infrared, a pulsed hot air, or other heater system.

The shape of an intermediate mold is determined from the shape of the following mold. The relationship between the shapes of two molds can be better understood from the example shown in FIGS. 2 to 4.

FIG. 2 shows an example of a part 8 that is to be manufactured. This part includes a central portion having a zone 9 that is greatly lengthened. In particular, the shape of the part includes sharp edges 10.

As mentioned above, a shape, a surface, or a curve (e.g. a sectioning curve or section) is regularized on being replaced by a respective shape, surface, or curve, of more regular curvature. This can apply for example with a shape, a surface, or a curve for which the smallest radius of curvature within the zone in question is increased from its initial value.

A first method of defining the shape of the intermediate mold consists in regularizing the shape of the following mold. This regularization may be performed in various ways.

In the example of FIG. 3, regularization can be performed by increasing the radii of curvature, in particular on the edges and the zones with a high degree of curvature. Advantageously, on this occasion, the curvature of the part is spread over a zone that is larger. For the example shown in FIG. 2, FIG. 3 shows the shape of an intermediate mold that can be used to prepare the material for the final step. The sharp edges 10 of FIG. 2 are replaced by fillets 11.

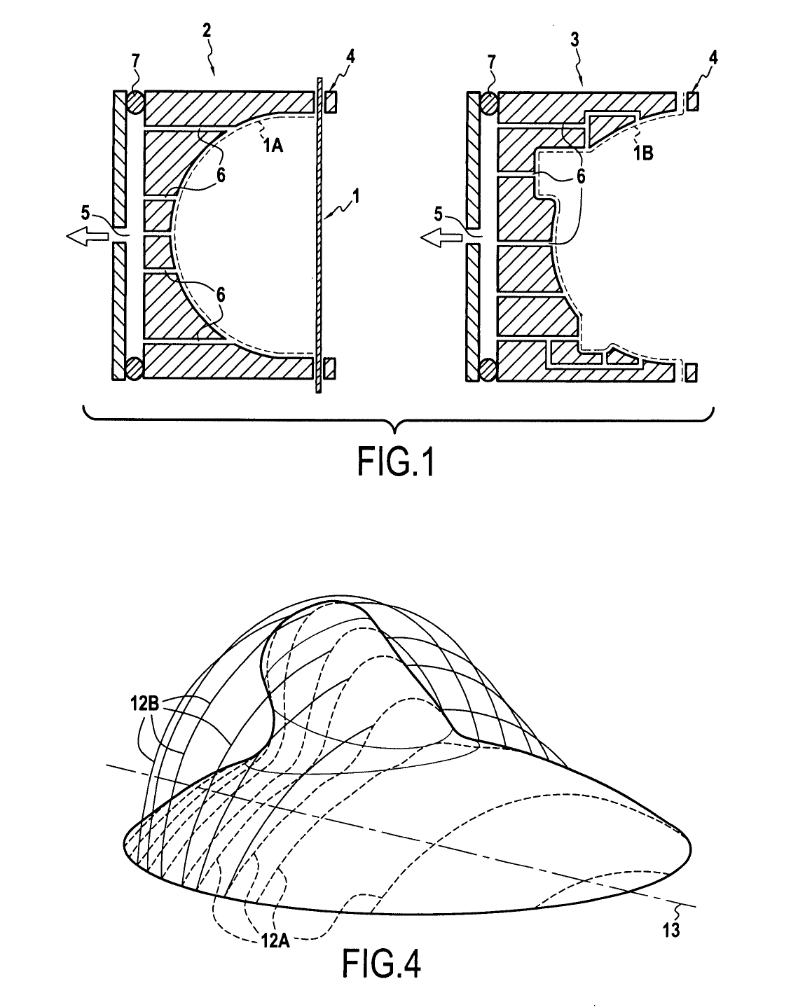

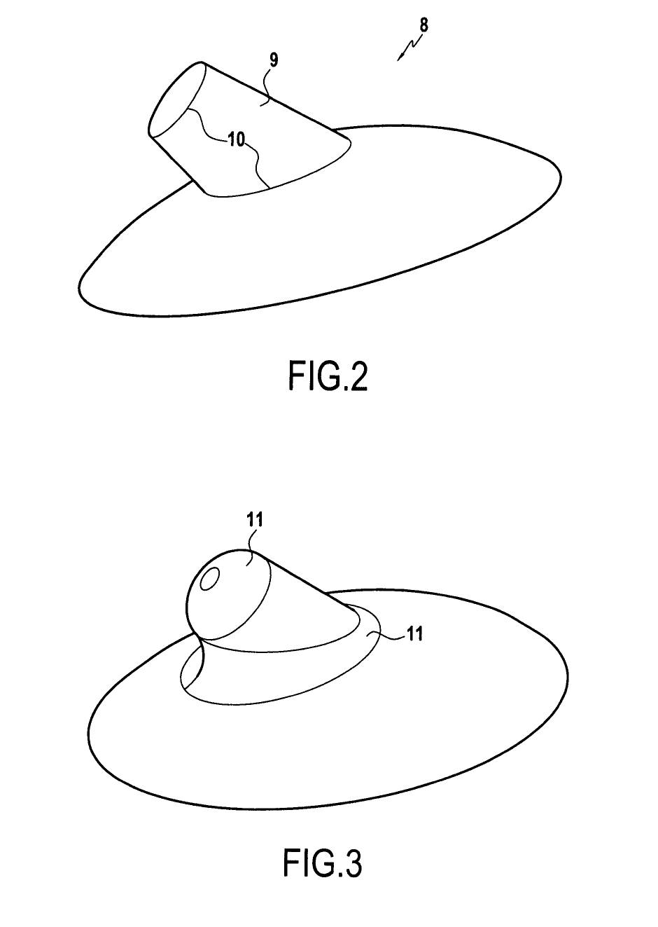

FIG. 4 shows another way of regularizing: in this example it is done by regularizing a set of selected sections 12. These sections may be selected in particular so as to be perpendicular to a common axis 13.

As shown in FIG. 4, on each section, an advantageous technique for regularizing the resulting curve consists in replacing the section by a curve having the same length. Preferably, a curve is selected that does not have a point of inflexion, such as an arc of a circle or of an ellipse, for example. FIG. 4 shows the starting sections 12A and the regularized sections 12B that are used for defining the intermediate mold. The shape of the mold may be obtained by interpolating between these sections, for example.

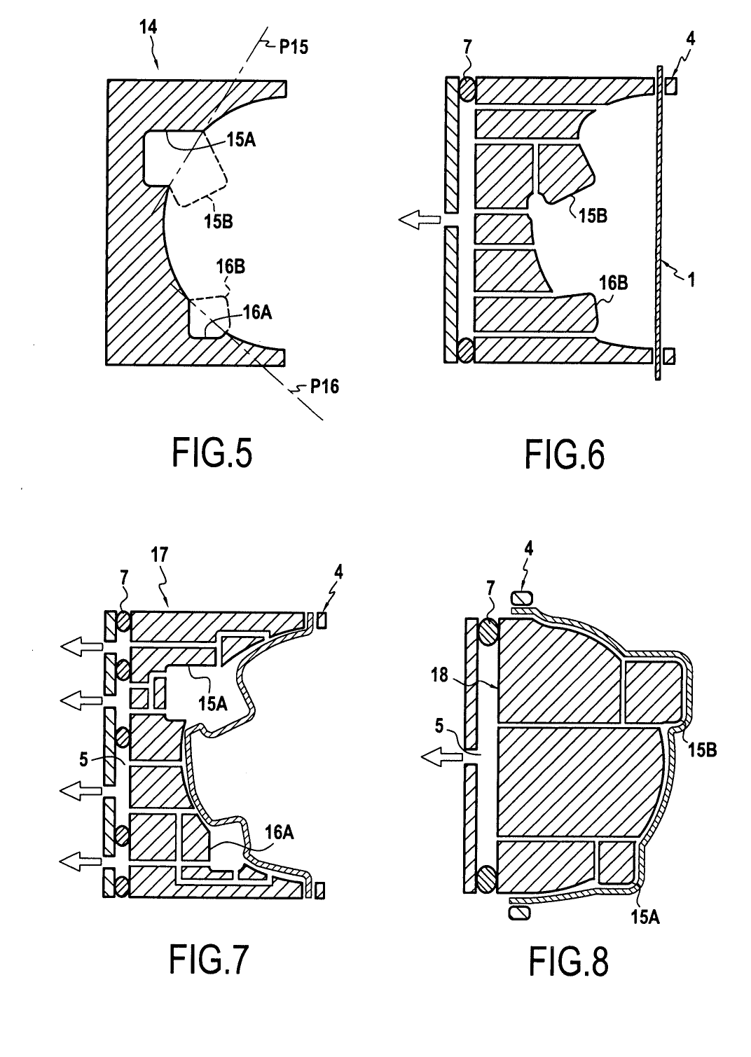

FIGS. 5 to 8 show another way of shaping intermediate molds. For certain complex shapes, and in particular for zones that require great lengthening of material, this method of defining an intermediate mold can give better results than the above methods.

FIG. 5 is a diagram for defining the shape of an intermediate mold. The shape 14 shown has two zones 15A and 16A that present a large amount of lengthening and that are difficult to make by thermoforming. In order to thermoform such zones successfully, the shape selected for the intermediate mold is obtained as follows:

two planes of symmetry P15 and P16 are determined. These planes are generally selected as planes of intersection between the highly elongated zone and the general shape of the part; and

details 15A and 16A are transformed symmetrically relative to said planes P15 and P16, thereby providing “mirror” shapes 15B and 16B of those two details.

Advantageously, the “inside-out” portions 15B and 16B come into contact with the membrane earlier on during the thermoforming operation. As a result, in the zones of inverted shape, the thickness of the resulting membrane is slightly greater. This has the effect of compensating the opposite effect that takes place during the following step (FIG. 7 or 8).

FIG. 6 shows the intermediate mold obtained from the shape designed by the above method.

FIG. 7 shows a first possibility for the final forming step following the intermediate step performed using the mold of FIG. 6. The plate 1 is fastened in the mold 17 by the holder system 4. Its shape thus comes from the way it was shaped in the mold of FIG. 6; specifically it includes the inverted shapes 15B and 16B.

The mold 17 may advantageously include a plurality of suction chambers so as to be capable of acting more specifically on the various zones of the part. In particular, this makes it possible to subject the inverted shapes to stronger suction, or to suction of longer duration, than the remainder of the part. An example of a mold with a plurality of suction chambers is shown in FIG. 7. While suction is applied to the mold, the shapes 15B and 16B invert and take on the desired shapes 15A and 16A.

FIG. 8 shows another possibility for the final forming step following the intermediate step performed with the mold of FIG. 6. Because certain membranes are very flexible, it is advantageous to envisage the final thermoforming step being performed on a male mold 18 as shown in FIG. 8. Zones such as 15B and 16B are then turned inside-out as soon as the preformed plate is clamped onto the mold.

More generally, the present invention defines a method of designing thermoforming units. According to the invention, the units are designed by complying during mold design with the rules specified above, and in particular:

forming is performed in a plurality of successive shaping steps;

a zone of a mold is defined by regularizing the corresponding zone of the mold for the following step, while advantageously conserving the developed lengths of section selected during the regularization operation; or

the zone of a mold is defined symmetrically about a plane of the corresponding zone on the mold of the following step.

A thermoforming unit defined by the invention is implemented as follows. The material used is initially substantially in the form of a sheet 1. Each of the forming steps complies with the following process:

the plate is clamped on the holder system;

the heater system is activated to soften the sheet;

the system for applying pressure and/or suction to the mold is activated, the pressure difference established between the faces of the sheet causing it to be deformed and pressed against the mold;

the heater and pressure/suction systems are stopped;

the shaped plate is removed; and

it is transferred to the following mold.

Advantageously, for a thermoforming unit fitted with a suction system, the system presents a flow rate that is variable so that the operator performing thermoforming can adjust the level of suction being applied as a function of the material and of the shape of the material.

This function is particularly useful with a mold that comprises a plurality of suction chambers, as proposed above.

When the material presents a change in translucency on reaching its crystalline melting temperature, the operator can make use of this property to optimize the duration of the stage of heating in the mold.

Thus, temperature during forming operations is controlled on the basis of observing changes in the translucency of the material being used. Ideally, during thermoforming, the material is raised only briefly to a temperature higher than its crystalline melting temperature.

Furthermore, when the material used possesses a specific elongation direction (the longitudinal axis of a membrane that has been expanded uniaxially, for example), and when the shape of the mold in question has been determined by modifying sections perpendicular to a given axis (axis 13 in FIG. 4, for example), the operator can advantageously position the sheet in the mold in such a manner that said elongation direction of the material is parallel to said axis that was used for designing the mold.

This method may advantageously be used with expanded materials. It is preferable to use membranes that are flexible in order to facilitate forming operations, and in particular clamping the plate of plastics material in the mold.

For these reasons, the method is particularly suitable for shaping expanded fluorinated thermoplastic materials, and in particular membranes based on PTFE. The flexibility of such membranes and their low adhesion contributes to the success of manufacture.

Furthermore, with such materials, when they are raised in temperature, the translucency of a plate changes on reaching the crystalline transition temperature. It is then possible merely to limit the duration of the time spent at high temperature so as to preserve the mechanical properties of the initial membrane as well as possible, while ensuring dimensional stability for the shape imposed during the forming.

The associated thermoforming unit described in this document, the method of designing molds that it includes, and the thermoforming method, enable parts to be obtained that are complex in shape, of dimensions that are stable, and with variations of thickness that are small.

Thus, the specific characteristics of the thermoforming unit defined by the invention, together with the flexibility and sliding properties of certain membranes made of plastics material, and in particular of PTFE, enable parts to be manufactured of shapes that have hitherto not been achievable using traditional thermoforming methods.

1. A unit for thermoforming a part out of plastics material, comprising at least two molds of respective shapes serving to cause the shape of the material being worked to vary progressively so that, at the final step, the final mold enables the desired shape to be obtained.

2. A unit according to claim 1, wherein, during at least one of the steps, the forming is performed with a mold being evacuated using a suction system.

3. A unit according to claim 1, wherein at least one of the molds is a female mold.

4. A unit according to claim 1, wherein the material being worked is initially substantially in the form of a sheet.

5. A unit according to claim 1, wherein the shape of a zone of a mold is defined by regularizing the corresponding zone of the following mold.

6. A unit according to claim 1, wherein the shape of at least one zone of one of the molds is determined from the shape of the corresponding zone of the following mold in such a manner as to regularize selected sections measured on said zone in the following mold.

7. A unit according to claim 6, wherein all or some of said sections are regularized by replacing the sections under consideration with curves that have the same ends and do not have points of inflexion, which curves may be constituted by circular arcs or by portions of an ellipse.

8. A unit according to claim 1, wherein the shape of at least one zone of one of the molds is determined from the shape of the corresponding zone of the following mold in such a manner as to conserve the developed lengths of selected sections measured over said zone.

9. A unit according to claim 1, wherein the shape of at least one zone of one of the molds is determined substantially by locally inverting the shape of the same zone of the following mold, by a symmetrical transformation about a plane.

10. A unit according to claim 1, wherein the area or the developed section lengths of the intermediate mold is or are greater than the corresponding area or developed section lengths of the following mold.

11. A method comprising implementing the thermoforming unit comprising at least two molds of respective shapes serving to cause the shape of the material being worked to vary progressively so that, at the final step, the final mold enables the desired shape to be obtained.

12. A method according to claim 11, wherein the material used is an expanded plastics material.

13. A method according to claim 12, wherein the material used for the method is an expanded fluorinated thermoplastic material.

14. A method according to claim 13, wherein the material is a material constituted for the most part by expanded PTFE.

15. A method according to claim 11, for a thermoforming unit fitted with a suction system, wherein said suction system possesses a variable flow rate.

16. A method according to claim 11, wherein temperature during one of the forming operations is controlled on the basis of observing changes in the translucency of the material being worked, when the material is one for which a change in translucency is associated with a change in the state or the microscopic structure of the material.

17. A method according to claim 11, wherein the material worked is raised briefly during a forming stage to a temperature higher than its crystalline melting temperature.

18. A method according to claim 11, when the material worked possesses a specific elongation direction and when the shape of an intermediate mold was determined by modifying sections perpendicular to an axis, wherein the material is put into place in the molds in such a manner that said direction is parallel to said axis.

19. A method of designing a thermoforming mold, in which the shape of an intermediate mold is designed from the shape of the following mold by regularizing a zone or sections over a zone, said regularization conserving developed section lengths measured over the modified zone.

20. A method of designing a thermoforming mold in which the shape of a mold is designed from the shape of the following mold by inverting the shape of certain zones symmetrically about planes.
